(19) United States
(12) Patent Application Publication
(10) Pub. No.: US 2007/0263632 A1
(43) Pub. Date: Nov. 15, 2007

(54) System and method for mediating information

(75) Inventors: Tsuneo Sobue, Tokyo (JP); Shigetoshi Sameshima, Machida (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/728,942

(22) Filed: Mar. 26, 2007

(30) Foreign Application Priority Data
Mar. 27, 2006 (JP) 2006-085396

(51) Int. Cl. H04L 12/56

(52) U.S. Cl. 370/395.2

(57) ABSTRACT

A mediation server acquires information on a regular basis from an information provider terminal unit. Upon receiving a request from a user terminal unit, the mediation server discloses information to the user terminal after converting the information into dummy information so that computer-assisted name identification cannot be applied to combination of respective items of attributes of an information provider and respective items of information on the information provider that are not permitted to be disclosed. When permission for disclosure is given to a user from the information provider, the mediation server provides related information for restoring the dummy information to the original status so that the user can perform computer-assisted name identification.

### CLAIM OF PRIORITY

The present application claims priority from Japanese application serial no. 2006-085396 filed on Mar. 27, 2007, the content of which is hereby incorporated by reference into this application.

### BACKGROUND OF THE INVENTION

The present invention relates to an information mediation system, and more specifically to a system which mediates information to be exchanged between a user and a provider, a system which externally discloses personal information or privacy information in a safe manner, and an information mediation system which enables a user to easily acquire personal information according to the situation.

In April 2005, full enforcement of the Private Information Protection Law started. Here, the private information is information that enables identification of a specified person, and it also includes such information that enables personal identification with the information itself, in addition to information that enables easy identification when combined with other information. Use of private information requires notification/authorization of the purpose of use by the principal person when acquiring private information, and provision of the information to a third person also requires agreement of the principal person.

Meanwhile, introduction of IT into automobiles has been carried out remarkably in recent years, and automobiles are being controlled by incorporating various information processing devices. Accordingly, by using various on-board information processing devices, it is now possible to collect various kinds of information such as engine rotation speed, application degree of brake and location information (route information) that flow within an automobile. As such vehicle information is deemed a type of private information, and a guideline for use of such information is being developed within the industry at present. Therefore, to mediate information including private information, vehicle information and privacy information, controls such as filtering and processing must be made depending on to whom and what information would be provided.

As a conventional art for mediating private information or privacy information, there is a method for deleting an item that identifies an individual person from information to be provided. Such method is, for example, described in the U.S. Unexamined Patent Publication 2003/0163416 (Patent Laid-open No. 2003-248780). Here, in a system for mediating settlement between a customer and an outlet store, the customer will enter information on the customer's name, home address, article to buy, etc. and send the data to the mediation system in order to do shopping from the outlet shop. The mediation system will delete only items, such as customer's name and home address from which the person can be identified, and the remaining information will be supplied to the outlet shop.

In addition, as another conventional art for mediating private information or privacy information, there is a method for providing information after converting the information into a specified index value. For example, with a method disclosed in the Japanese Patent Laid-open No. 2003-288526, in a mediation system intended for Internet auctions, purchaser's security will be achieved, while protecting private information or privacy information between an exhibitor and the purchaser. With the Japanese Patent Laid-open No. 2003-288526, when disclosing information on an exhibitor to a purchaser, the information will be provided after converting it into another index (relative relationship with the purchaser in this case) such as “the exhibitor lives in the same area” or “the exhibitor is of the same age”, without disclosing the name and address as they are. With such arrangement, the purchaser can effect purchasing with a certain level of security, even if the exhibitor does not need to disclose the private information or the privacy information.

### SUMMARY OF INVENTION

The above-stated method for deleting items as described in the U.S. Unexamined Patent Publication 2003/0163416 (Patent Laid-open No. 2003-248780) has a problem that measures cannot be taken when an individual needs to be identified after providing information that is already deleted and anonymized. For example, in the field of automobiles, an automobile manufacturer collects vehicle information such as routes from vehicles. In case such collected vehicle information is externally disclosed to an insurance company (hereinafter referred to as the “Insurance”) or the like, the information cannot be disclosed under the status that an individual can be identified due to restrictions by the Private Information Protection Law, etc. When information is externally provided such as to the Insurance, items such as name, address and telephone number that can identify an individual must be deleted to anonymize the information.

On the other hand, as a result of improved safety of vehicles, the Insurance is demanded to have lineups of detailed insurance menus that can satisfy needs of certain customers apart from conventional insurance that covers all persons concerned. It is possible to conduct marketing analysis by utilizing anonymized information and plan a new insurance menu. However, to actually implement the service, there are no measures for effectively performing promotional activities to attract target customers, such as sending of direct mails, since individuals are not identified yet. In addition, tremendous amount of information is required to conduct such marketing analysis, and much time will be required for collecting information.

Further, with the above-stated method for converting information into an index value as disclosed in the Japanese Patent Laid-open No. 2003-288526, since an individual cannot be identified only with information converted into an index value as is the case with the method for deleting the above-stated items, the method can be utilized for marketing analysis, but it is not possible to attract attention of customers to be provided with the service. Identification of an individual becomes mandatory to perform promotional activities such as direct mails. Furthermore, with the method for converting information into an index value, when the Insurance, etc. is going to conduct marketing analysis, the type of an intended service may be predicted from the index value, which may allow the automobile manufacturer to which the mediation system is to be provided to realize the similar service in advance. From the viewpoint of the Insurance, it is desirable to acquire customer information through the automobile manufacturer, but types of analysis conducted should be concealed.

The present invention is made to solve the above-stated problems, and an object thereof is, in a system for mediating information which mediates information between a user and a provider, to provide a system for mediating information wherein a mediating system can periodically accumulate information on the provider, define the scope of disclosing provided information to a user based on detailed conditions including past information that is already accumulated by the provider, and change the way of disclosing information.

Further, another object of the present invention is to provide a system for mediating information which enables a user to cancel anonymity of already-provided information by providing a user with information at first after being processed for computer-assisted name identification, and subsequently providing the user with the related information for computer-assisted name identification of a plurality of information.

With the system for mediating information according to the present invention, an information provider terminal unit and a user terminal unit are connected to a network via a mediation server. The information provider terminal unit is, for example, an on-board terminal unit to be incorporated in an automobile and the user terminal unit is a terminal that is used by a user of the insurance who plans automobile insurance.

A mediation server is connected with a server which manages attributes of an information provider, a server which manages information on the information provider and a server which manages user information.

The mediation server collects information from an information provider terminal unit on an irregular or a regular basis and transmits information on the information provider to a management server for storage.

In the server which manages user information, conditions for disclosing information items of an information provider and attribute items of the information provider according to companies, business categories, departments, etc.

Upon receiving a request from a user terminal unit, the mediation server receives information from the server which manages attributes of an information provider and the server which manages information on the information provider, and discloses the information to the user terminal after replacing the information with dummy information to prevent computer-assisted name identification for combination of attribute items of the information provider and information items of the information provider that are not permitted to be disclosed.

Further, the mediation server can transmit a disclosure request to an information provider terminal unit from a user terminal unit via a mediation server. When permitted by the information provider, the mediation server generates related information that can restore dummy information for which computer-assisted name identification is prohibited to the original status and transmits the information to the user terminal unit.

With such arrangement, it is possible for a provider to set up information disclosure based on detailed conditions such a date and business category of a user, including past information that are already accumulated by a provider, by allowing the mediation system to accumulate provider information on an irregular or a regular basis. Furthermore, it is also possible to cancel anonymity of information already-provided to a user by providing the user with information at first after being processed for computer-assisted name identification, and by subsequently providing the user with related information to be used for computer-assisted name identification of a plurality of information. Since the user can collect information including past information, it is possible for the user to shorten time for collecting information, which leads to earlier execution of marketing analysis or service implementation.

According to the present invention, it is possible to offer a system for mediating information between a user and a provider, wherein a mediation system periodically accumulates provider information, and the provider can define the disclosure scope of provided information, including past information already accumulated by the provider, to the user based on detailed conditions, thus enabling the provider to change the way of disclosing information.

Further, it is also possible to offer a system for mediating information that enables the user to cancel anonymity of information already-provided to the user by providing the user with information after being processed for computer-assisted name identification, and by subsequently providing the user with related information to be used for computer-assisted name identification of a plurality of information.

### BRIEF DESCRIPTION OF THE DRAWINGS

FIG. 1 is a schematic system diagram of a system for mediating information according to a preferred embodiment of the present invention.

FIG. 2 is a functional block diagram of a system for mediating information according to the preferred embodiment of the present invention.

FIG. 3 is a diagram illustrating a detailed structure of user information 242.

FIG. 4 is a diagram illustrating a detailed structure of disclosure conditions 244.

FIG. 5 is a diagram illustrating a detailed structure of member information 222.

FIG. 6 is a diagram illustrating a detailed structure of vehicle information 235.

FIG. 7 is a diagram illustrating a detailed structure of acquired information 203.

FIG. 8 is a diagram illustrating a detailed structure of a provision history 213.

FIG. 9 is a diagram illustrating a detailed structure of a disclosure pattern 216.

FIG. 10 is a diagram illustrating a detailed structure of vehicle information 255.

FIG. 11 is a diagram illustrating a detailed structure of a processing history 233.

FIG. 12 is a flow chart illustrating processing that an information provision unit 211 returns a response, responding to a request from an information acquisition unit 202.

FIG. 13 is a flow chart illustrating processing steps for computer-assisted name identification.

FIG. 14 is a diagram illustrating processing steps of route information.

FIG. 15 is a flow chart illustrating processing that an information provision unit 211 returns related information, responding to a request from an information acquisition unit 202.

FIG. 16 is a sequence diagram for processing vehicle information collection between an on-board terminal unit 117 and a mediation server 105.

FIG. 17 is a sequence diagram for processing steps of disclosing information to a driver 116 by a user 101.

FIG. 18 is a diagram illustrating an example of information disclosure request window to be displayed on the window of the on-board terminal unit 117.

FIG. 19 is a flow chart illustrating processing steps for executing marketing analysis and implementing service to a customer by the Insurance.

FIG. 20 is a diagram illustrating a display example of information provided by a customer to be displayed on a user terminal unit 102.

### DETAILED DESCRIPTION OF THE PREFERRED EMBODIMENTS

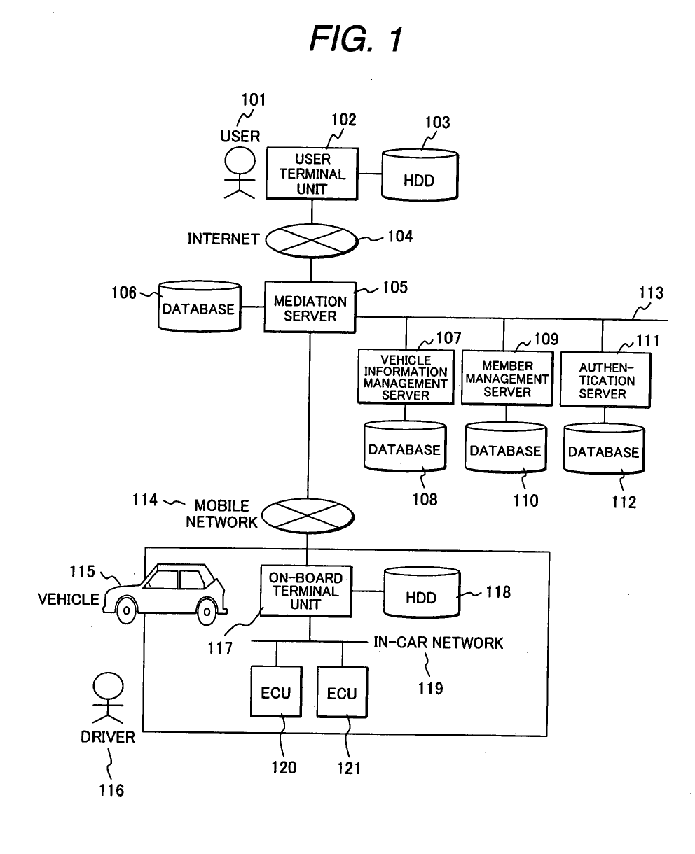

Hereinafter, a preferred embodiment according to the present invention will be described with reference to FIGS. 1 to 20.

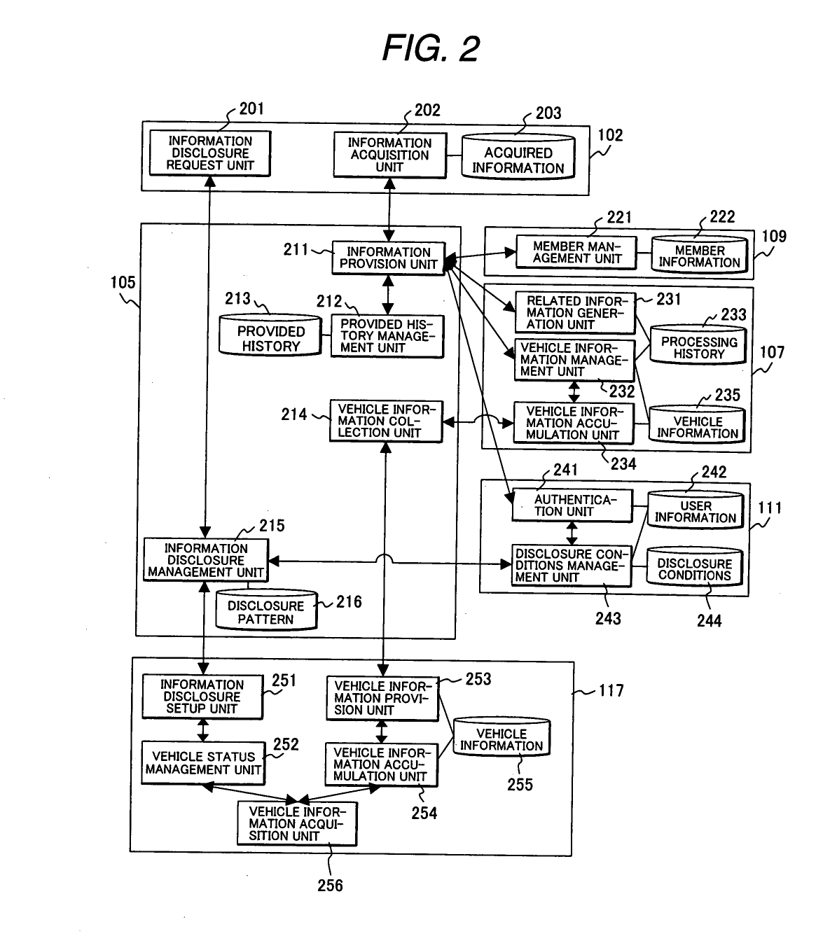

First, a configuration of a system for mediating information according to the embodiment of the present invention will be described with reference to FIGS. 1 and 2.

FIG. 1 is a schematic system diagram of a system for mediating information according to a preferred embodiment of the present invention.

FIG. 2 is a functional block diagram of a system for mediating information according to the preferred embodiment of the present invention.

The system for mediating information according to the embodiment is configured, as shown in FIG. 1, with a user terminal 102, a mediation server 105, a vehicle information management server 107, a member management server 109, an authentication server 111 and a vehicle 115.

The user terminal 102 is connected with a hard disk 103. The mediation server 105, the vehicle information management server 107, the member management server 109 and the authentication server 111 manage databases 106, 108, 110 and 112, respectively. Databases 106, 108 110 and 112 systematically manage data and define methods for accessing thereto, and they may be files or memory instead of databases. The user terminal unit 102 is a terminal unit to be operated by the user 101, and, for example, the user 101 will be a member staff of product planning department of an insurance company and the user terminal unit will be a personal computer of the insurance company. The user terminal 102 and the mediation server 105 are connected each other via the Internet 104. The Internet 104 may either be of wired connection or wireless connection. Further, the user terminal unit 102 and the mediation server 105 may be connected with a dedicated cable. For example, the mediation server 105, the vehicle information management server 107, the member management server 109 and the authentication server 111 are servers that are managed by a car manufacturer. The mediation server 105, the vehicle information management server 107, the member management server 109 and the authentication server 111 are connected with each other via a corporate network 113. The corporate network 113 may be of wired connection or wireless connection. The mediation server 105 collects information from vehicle 115 of a customer and provides information to a third party such as the Insurance.

The vehicle information management server 107 is a server which is used for accumulating vehicle information collected from the vehicle 115, and the vehicle information is stored in the database 108.

The member management server 109 is a sever which is used for managing customer information such as name or address, and the customer information is stored in the database 110.

The authentication server 111 is a server which is used for authenticating whether the user 101 is the authorized user or not, and information necessary for authentication is stored in the database 112.

The vehicle 115 comprises an on-board terminal unit 117, a hard disk 118, ECU 120 and 121. The ECU (Electric Control Unit) is an electronic control device that controls the engine, wheel drive/brake mechanisms, etc. The on-board terminal unit 117 and ECU 120 and 121 are connected with each other via an in-car network 119, and the on-board terminal unit 117 can acquire information such as engine rotation speeds and the accelerator pedal position that is stored in the ECU 120 and 121. The hard disk 118 is used for accumulating vehicle information collected from the ECU 120 and 121, and it may be flush memory or the like. In addition, the hard disk 118 may either the one fitted into the on-board terminal unit 117 or an external device that is connected with a cable such as a USB cable. A mobile phone is connected to the on-board terminal unit 117, and the on-board terminal unit 117 and the mediation server 105 will be connected via a mobile network 114. It should be noted, however, that, with the embodiment, it is assumed that an owner of a vehicle and the driver 116 will be assumed to be the same person. The person who provides information as an information provider to the user 101 is the driver 116.

Next, a functional configuration of the system for mediating information according to the embodiment will be described with reference to FIG. 2.

The user terminal unit 102 comprises an information disclosure request unit 201 and an information acquisition unit 202 and holds acquired information 203 as data thereof. A physical medium in which the acquired information 203 is stored in the hard disk 103.

The mediation server 105 comprises an information provision unit, a provision history management unit 212, a vehicle information collection unit 214 and an information disclosure management unit 215, and holds a provision history 213 and a disclosure pattern 216 as data thereof. The provision history 213 and the disclosure pattern 216 are stored in the database 106. The member management server 109 comprises a member management unit 221 and holds member information 222 as data thereof. The member information 222 is stored in the database 110.

The vehicle information management server 107 comprises a related information generation unit 231 and a vehicle information management unit 232 and holds a processing history 233 and vehicle information 235 as data thereof. The processing history 233 and the vehicle information 235 are stored in the database 108.

The authentication server 111 comprises an authentication unit 241 and a disclosure conditions management unit 243 and holds user information 242 and disclosure conditions 244 as data thereof. The user information 242 and the disclosure conditions 244 are stored in the database 112.

The on-board terminal unit 117 comprises an information disclosure setup unit 251, a vehicle status management unit 252, a vehicle information provision unit 253, a vehicle information accumulation unit 254 and a vehicle information acquisition unit 256 and holds vehicle information 255 as data thereof. The physical medium in which the vehicle information 255 is stored is the hard disk 118.

The information acquisition unit 202 transmits a request to the information provision unit 211 and accumulates the result obtained in the acquired information unit 203. For example, a member staff of product planning department of the Insurance collects vehicle information (regarding how the vehicle is used) of a customer through a car manufacturer for the purpose of examining a new insurance menu. The information provision unit 211 refers to the authentication unit 241 to checks if the user is an authorized user or not and investigates if the designated information can be disclosed or not. If the information can be disclosed, the information provision unit 211 refers to the member management unit 221 or the vehicle information management unit 232, acquires information, and replies the result information thus acquired to the information acquisition unit 202.

The information disclosure request unit 201 transmits an information disclosure request to the driver 116 via the mediation server 105. This means that an insurance company requests the driver 116 to disclose information that is necessary for marketing analysis. The information disclosure management unit 215 which is in the mediation server 105 sends the request to the information disclosure setup unit 251 which is in the on-car terminal unit 117 and displays the request on the screen of the on-car terminal unit 117. If permission is obtained from the driver 116, the information disclosure management unit 215 sends permission information to the disclosure conditions management unit 243 and set disclosure conditions. Further, the information disclosure management unit 215 replies the result regarding if disclosure is permitted or not to the information disclosure request unit 201.

The vehicle information collection unit 214 collects vehicle information via the vehicle information provision unit 253 which is in the on-car terminal unit 117 and accumulates the collected vehicle information via a vehicle information accumulation unit 234. As for the vehicle information, the vehicle information collected from the vehicle information acquisition unit 256 is stored in the vehicle information 255 via the vehicle information accumulation unit 254. The vehicle information acquisition unit 256 includes a function to acquire information from ECU 120 and 121 via the in-car network 119.

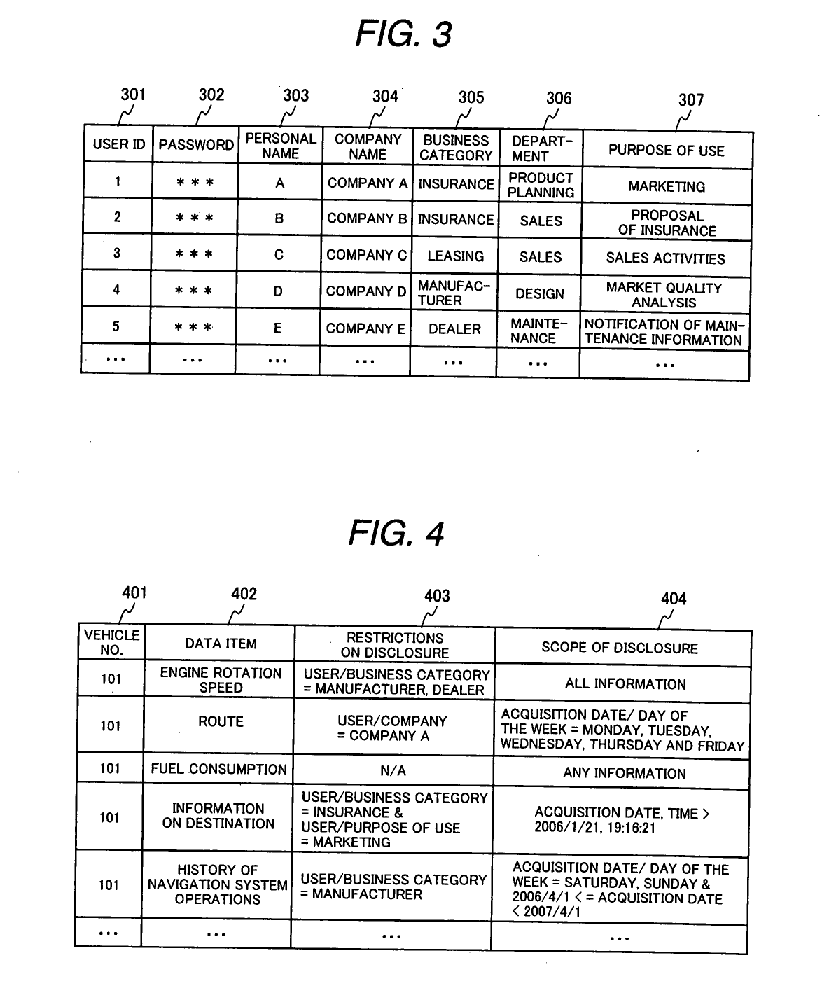

Next, a data configuration of the system for mediating information according to the embodiment of the present invention will be described with reference to FIGS. 3 to 11.

FIG. 3 is a diagram illustrating a detailed structure of user information 242.

The user information 242 comprises, as shown in FIG. 3, items of a user ID 301, a password 302, a personal name 303, a company name 304, a business category 305, a department 306 and a purpose of use 307. The user ID 301 is used for uniquely identifying a user. For an information acquisition request to the information provision unit 211 from the information acquisition unit 202, the user ID 301 and the password 302 are designated. The authentication unit 241 executes authentication by using the user ID 301 and the password 303. The name 303 shows the name of user; the company name 304, the name of company to which the user belongs; the business category 305, the category of company to which the user belongs; the department 306, the department to which the user belongs in the company; and the purpose of use 307, the method of using acquired vehicle information, respectively.

FIG. 4 is a diagram illustrating a detailed structure of disclosure conditions 244.

The disclosure conditions 244 manages conditions for disclosing vehicle information associating with attributes of each user as shown in FIG. 4 and comprises a vehicle number 401, a data item 402, restrictions on disclosure 403 and a scope of disclosure 404. The vehicle number 401 is used to uniquely identify the vehicle 115. The data item 402 shows data to be disclosed. There are many types of vehicle information, some examples of which are engine rotation speed, route (a plurality of location information), fuel consumption, destination information of NAVI (navigation) and operation histories of NAVI. Conditions for disclosure can be set for each data item. The restrictions on disclosure 403 show a use permission of a specified vehicle to a user of a special data item represented by the data item 403. For the restrictions on disclosure 403, users are restricted by using attribute information of the users. Attribute information of user include the personal name 303, the company name 304, the business category 305, the department 306 and the purpose of use 307. For example, a restriction “disclosure is limited to users whose business category is manufacturer or dealer” will be set. Of course, such restriction “disclosure is limited to users whose business category is not dealer” can also be set. The scope of disclosure 404 shows conditions to be designated when part of data items are disclosed, for example. For the scope of disclosure 404, it is possible to restrict if disclosure should be made or not by designating the acquisition date (including day of the week, time, etc.), location, etc. For example, designation may be made in the manner: “only weekdays (Monday, Tuesday, Wednesday, Thursday and Friday) can be disclosed”, “information on peripheral areas of home cannot be disclosed, “information on and after Jan. 23, 2006 can be disclosed. “For the disclosure conditions management unit 243, regarding an acquisition request from the information acquisition unit 202, judgment is made as to whether disclosure of provided information by using information of the disclosure conditions 244 of provided information is possible or not.

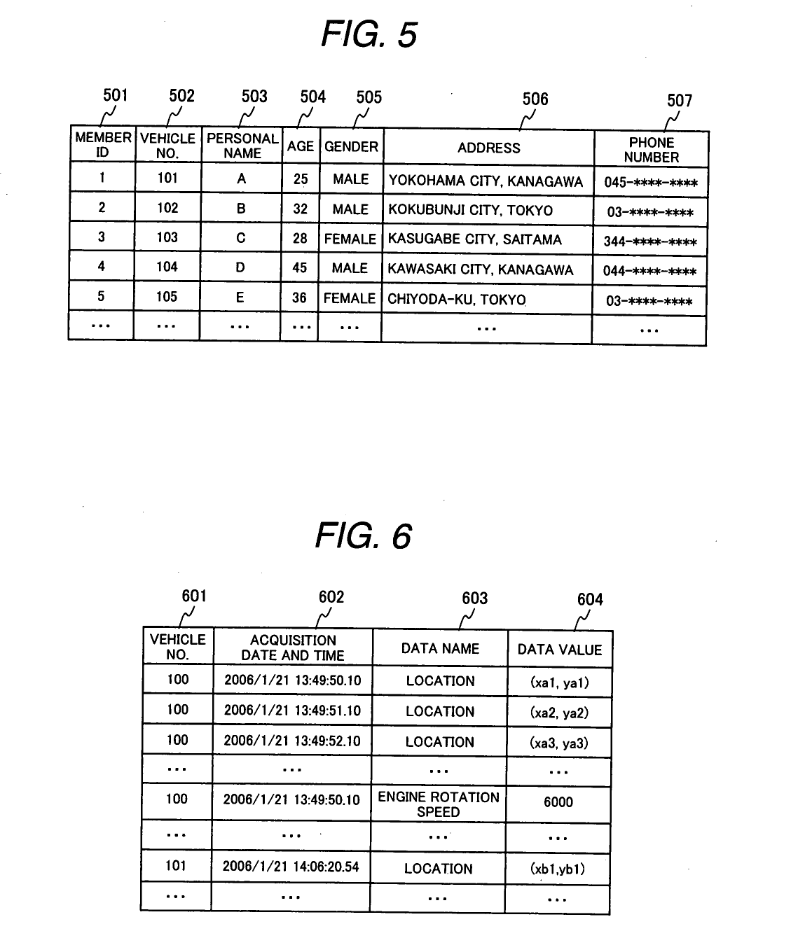

FIG. 5 is a diagram illustrating a detailed structure of member information 222.

The member information 222 comprises, as shown in FIG. 5, items of a member ID 501, a vehicle number 502, a personal name 503, age 504, gender 505, an address 506 and telephone number 507.

With the system a vehicle owner (the driver 116) shall be registered in the user association hosted by a car manufacturer.

The member ID 501 is used to uniquely identify a member. The vehicle number 502 is the number of the vehicle owned by the member, and the vehicle number 502 is an identifier to uniquely identify the vehicle. The personal name 503 is the name of the member; the age 504, the age of the member; the gender 505, the gender of the member; the address 506, the address of the member; and the telephone number 507, the telephone number of the member. According to the Private Information Protection Law, private information cannot be provided to a third party such as the Insurance without authorization. Since information such as personal name, address and telephone number fall into private information, they cannot be provided in the form as they are. In case disclosure of information is not permitted, details such as the block number of address require processing of deletion, for example.

FIG. 6 is a diagram illustrating a detailed structure of vehicle information 235.

The vehicle information 235 comprises, as shown in FIG. 6, items of a vehicle number 601, acquisition date and time 602, a data name 603 and a data value 604.

The vehicle number 601 is used for uniquely identifying a vehicle. The acquisition date and time 602 shows the date and the time when the vehicle information management server 107 acquired the data; the data name 603, the name of the data; and the data value 604, the value of the data name 603. For example, the data name 603 is “location”, and the data value 604 associating with the data name is “x, y (s: latitude, y: longitude).

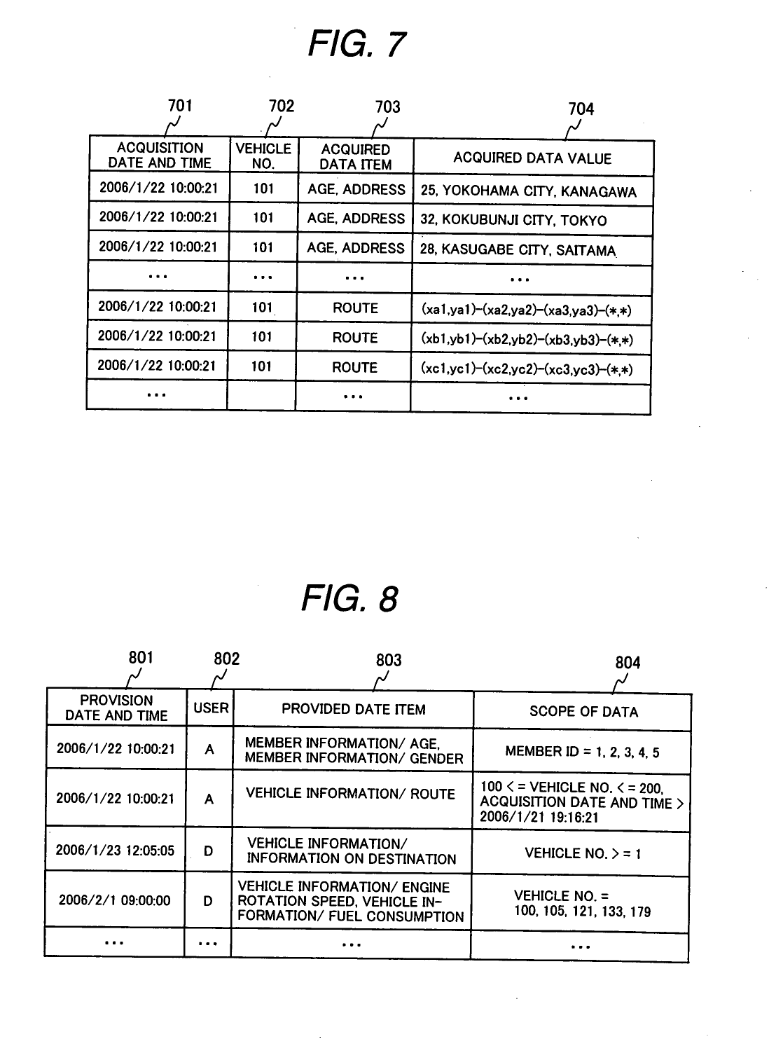

FIG. 7 is a diagram illustrating a detailed structure of acquired information 203.

The acquired information 203 comprises, as shown in FIG. 7, items of acquisition date and time 701; a vehicle number 702; an acquired data item 703; and an acquired data value 704. The vehicle number 702 is used for uniquely identifying a vehicle. The vehicle number 702 is same as the vehicle number 601 of the vehicle information 235. The acquired data item 703 shows the name of the data; and the acquired data value 704 the value of the acquired data item 703. The acquired data and time 701 shows the date and the time when the acquired data value 704 was acquired in the vehicle 115, and not the date and the time when the information acquisition unit 202 acquired the information.

FIG. 8 is a diagram illustrating a detailed structure of a provision history 213.

The provision history 213 comprises, as shown in FIG. 8, items of provision date and time 801, a user 802, provided data 803 and scope of data 804. The provision data and time 801 shows the date and time when the information provision unit 211 provided data to the information acquisition unit 202. The user 802 shows the person who provided the information; the provided data 803, the data item that was provided. The scope of data 804 shows a condition that was used for providing part of the data. For example, the provided data 803 includes age and gender of the member information, and the scope of data includes a case where the member ID ranges from 1 to 5 (data of five persons).

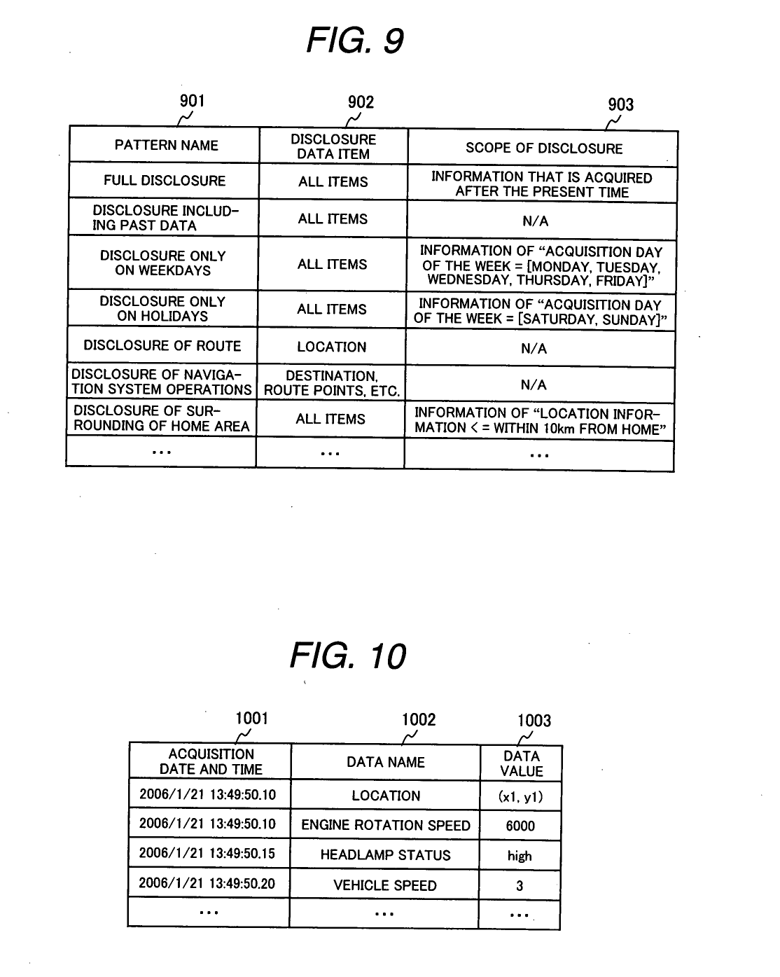

FIG. 9 is a diagram illustrating a detailed structure of a disclosure pattern 216.

The disclosure pattern 216 comprises, as shown in FIG. 9, items of a pattern name 901, a disclosed data item 902 and scope of disclosure 903. The pattern name 901 shows the name of a pattern clearly specifying a combination pattern of the disclosed data item 902 and the scope of disclosure 903. In addition, when a disclosure request is displayed to the driver 116, the pattern name 901 is displayed on the window of the on-board terminal unit 117. The disclosed data item 902 shows a data item to be disclosed, and these items including “all items” and “location” are designated. The scope of disclosure 903 shows the scope of data items to be disclosed. For example, “acquisition day of the week =[Saturday, Sunday]“or “location information<=within 10 km from home” is designated. The disclosure pattern 216 is used to enable easy disclosure, since it becomes not necessary for a user to set disclosure for each item when disclosing information by defining the pattern in advance.

FIG. 10 is a diagram illustrating a detailed structure of vehicle information 255.

The vehicle information 255 comprises, as shown in FIG. 10, items of acquisition date and time 1001, a data name 1002 and a data value 1003. Likewise the vehicle information 235, the acquisition date and time 1001 shows the date and time when the data was acquired, the data name 1002 the name of the data, and the data value 1003 the value of the data name 1002. The vehicle information is acquired and accumulated from the ECU 120 and 121 via the in-car network 119.

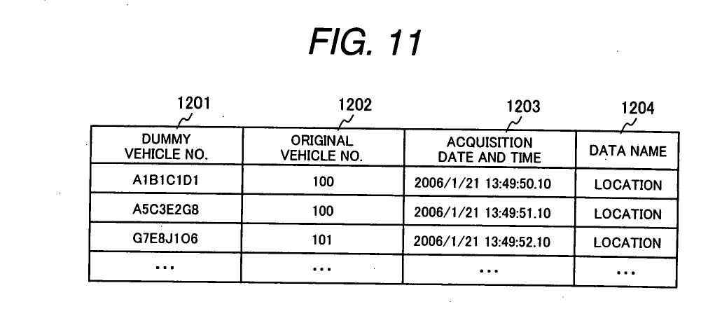

FIG. 11 is a diagram illustrating a detailed structure of a processing history 233.

The processing history 233 comprises, as shown in FIG. 11, items of a dummy vehicle number 1201, an original vehicle number 1202, acquisition date and time 1203 and a data name 1204. The dummy vehicle number 1201 shows a value that is obtained by processing a vehicle number into dummy information to prevent computer-assisted name identification, and the original vehicle number shows the original vehicle number before it is processed. The acquisition date and time 1203 shows date and time when the vehicle information was acquired, and the data name 1204 shows an item of the vehicle information. By using the vehicle number 1202, the acquisition date and time 1203 and the data name 1204, it is possible to uniquely identify the data.

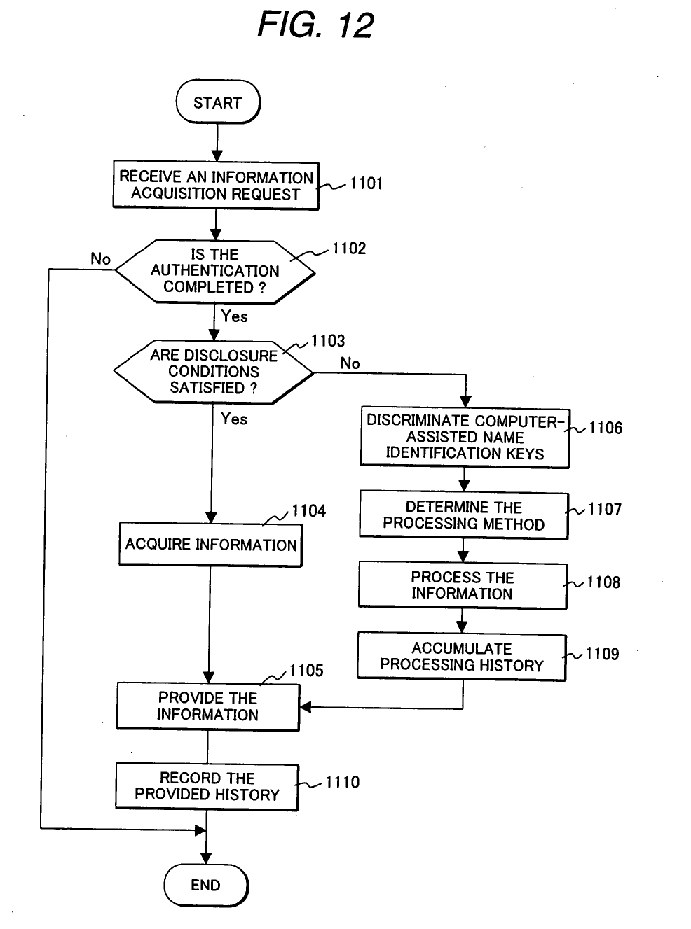

Next, operations of the system for mediating information according to the present invention will be described with reference to FIGS. 12 to 20.

First, processing that the information provision unit 211 returns a response to an information acquisition request from the information acquisition unit 202 will be described with reference to FIG. 12.

FIG. 12 is a flow chart illustrating processing that an information provision unit 211 returns a response, responding to a request from an information acquisition unit 202.

First, the information provision unit 211 of the mediation server 105 receives an information acquisition request from the information acquisition unit 202 of the user terminal unit 102 (Step 1101). Here, a user ID, a password and a data item to be acquired (including designation of conditions such as a vehicle number) are designated to the information provision unit 211 by the information acquisition unit 202. Next, authentication is executed as to confirm whether the user is an authorized user or not (Step 1102). For the authentication processing, the user ID and the password are transmitted by the information provision unit 211 to the authentication unit 211. The authentication unit 241 refers to the user information 242 to confirms whether combination of the designated user ID and the password has been registered or not. If it has been registered, the authentication unit 241 replies successful authentication, or a result of failed authentication if not registered, to the information provision unit 211. For the case of successful authentication, the authentication unit 241 advances the step to Step 1103, or, for the case of failed authentication, it notifies failure to the information acquisition unit 202 and terminates the processing.

Next, disclosure conditions for the designated data item are confirmed (Step 1103). The information provision unit 211 transmits the data item that is requested to be acquired to the disclosure conditions management unit 243 via the authentication unit 241. The disclosure conditions management unit 243 searches an appropriate data item by referring to the disclosure conditions 244 shown in FIG. 4 to determine whether the user satisfies conditions of the restrictions on disclosure 403 or not. It should be noted that, for attribute information of the user, the user information 242 shall be referred to. The information provision unit 211 then transmits the result regarding if the restrictions on disclosure are satisfied or not and the scope of disclosure that is set for each data item to the information provision unit 211. In case disclosure is permitted, the step advances to Step 1104.

Next, for the case that disclosure is permitted, the information provision unit 211 acquires designated information (Step 1104). More specifically, the information provision unit 211 acquires the member information 222 via the member management unit 221 and acquires the vehicle information 235 via the vehicle information management unit 232.

On the other hand, when the disclosure conditions are not satisfied, the step advances to Step 1106. With the embodiment, it shall be understood that, for a case that a user does not satisfy disclosure conditions and disclosure is prohibited to the user, provision of information cannot be carried out in a manner enabling identification of an individual, but the information can be provided in a manner that the information is anonymized. More specifically, it shall be understood that, for the case of the vehicle information 235, since an individual cannot be identified only with the vehicle information itself in most cases, the information can be provided even if the user does not satisfy the disclosure conditions. It should be noted, however, that combination of the member information 222 and the vehicle information 235 cannot be provided as they are since an individual can be identified by applying computer-assisted name identification by using the member information 222 and the vehicle information. This means that, for a case that disclosure is not permitted to the user, the information must be processed to prevent computer-assisted name identification.

For the reason stated above, keys for computer-assisted name identification are discriminated if the disclosure conditions are not satisfied (Step 1106). For example, for the case of the member information 222 and the vehicle information 235, computer-assisted name identification is possible by using the vehicle information 235.

Next, the method for processing the vehicle information 235 in the vehicle information management unit 232 is determined (Step 1107). More specifically, computer-assisted name identification is precluded by rewriting the computer-assisted name identification value obtained in Step 1106 to dummy information. For example, referring to the member information 222 shown in FIG. 5, the vehicle number of the member ID “1” is stated as “101.” Therefore, conversion of the number “101” which is the value of the vehicle number of the vehicle information 235 to the form “G7E8J106” precludes computer-assisted name identification with the member information 222. Further, since the dummy information is a value that is meaningless for a user, the user cannot restore the dummy vehicle number to the original vehicle number. The rule to rewrite a vehicle number to dummy vehicle information may be converted by using either; a random variable; time information; an internal serial number; or a data item. In addition, the rule for rewriting the vehicle number to dummy information may be changed for each date, each day of the week or at regular time intervals.

Then, the computer-assisted name identification keys are processed according to the processing rule of Step 1107 (Step 1108). Lastly, the processing history 233 as shown in FIG. 11 is accumulated (Step 1109), the acquired information is replied to the information acquisition unit 202 to terminate the processing (Step 1105).

In the processing steps shown above, it was described that the information is provided after being processed. However, for information for which computer-assisted name identification is likely to be carried out from the provision history 213 shown in FIG. 8, a method for preventing information provision could also be likely.

More specifically, when the fact that a certain user acquired the member information 222 including the vehicle number 502 of a certain member is recorded on the provision history 213 and disclosure of the vehicle information 235 of the member to the user is prohibited, the vehicle number is provided after being replaced with dummy information.

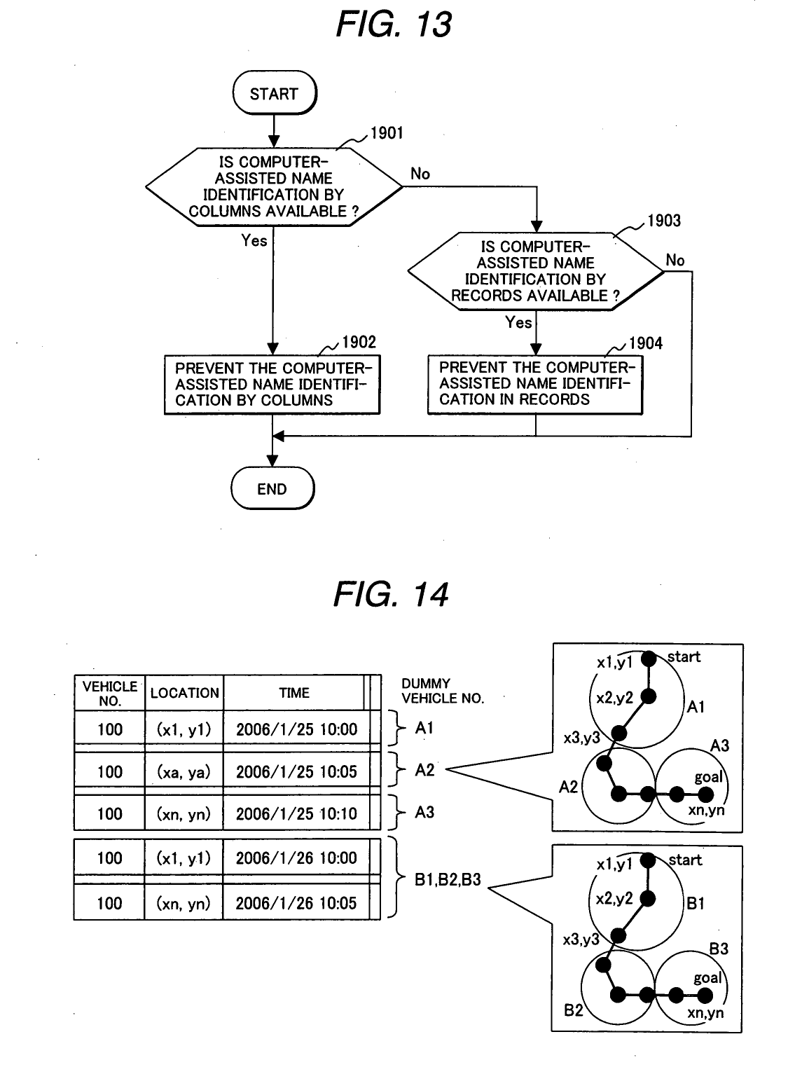

Next, processing steps for computer-assisted name identification will be described with reference to FIG. 13.

FIG. 13 is a flow chart illustrating processing steps for computer-assisted name identification.

Patterns of computer-assisted name identification can mainly be classified into two types: a case that uses columns; and a case that uses records.

The case that uses column is a pattern wherein computer-assisted name identification is applied to Item X on Table A and Item X on Table B. For example, the case that computer-assisted name identification is applied to member information and vehicle information by a vehicle number falls under the pattern.

On the other hand, the case that computer-assisted name identification is applied by records is a pattern wherein computer-assisted name identification is applied to Record 1 on Table A and Record 2 on Table A. For example, application of computer-assisted name identification to departure point information of route information, halfway point information and arrival point information for creating a single piece of route information falls into the pattern. For processing inputs, groups of records of two tables are given. First of all, check is made as to whether computer-assisted name identification is possible by columns (Step 1901). More specifically, search is made whether columns having the same name exist or not in the designated two tables. If they exist, computer-assisted name identification by columns is possible, and the step advances to Step 1902. If they do not exist, computer-assisted name identification is not possible, and the step advances to Step 1903. Here, judgment that columns having different names are same may be made by using a column name conversion dictionary. Further, judgment that column names in different expression are same may be made by using a synonym dictionary. For example, synonyms include a computer and a “computing machine.” Then, processing is applied to computer-assisted name identification items of respective tables (Step 1902), and the processing is terminated.

When computer-assisted name identification is not possible by columns, check is made whether computer-assisted name identification by records is possible or not (Step 1903). It shall be understood that data items to which computer-assisted name identification can be applied are defined separately. For example, in the case of route information, “location” should be the target. It should be noted that a processing example of detailed route information will be described later on. Here, by searching designated groups of records, check is made whether records that are eligible for computer-assisted name identification exists or not in the same data items of a same vehicle. If they exist, computer-assisted name identification by records is possible, and the step advances to Step 1904. If they do not exist, computer-assisted name identification is not possible, and, since there is no need to apply processing (computer-assisted name identification is not possible originally), the processing is terminated.

When computer-assisted name identification by records is possible, items of computer-assisted name identification of respective records are processed into different values to prohibit computer-assisted name identification by records, and then the processing is terminated (Step 1904).

Next, as an example of processing steps for the case that computer-assisted name identification by records is possible, processing steps of route information will be described with reference to FIG. 14.

FIG. 14 is a diagram illustrating processing steps of route information.

Normally, an individual cannot be identified by vehicle information itself. However, for a distribution truck, since the truck may travel on the same route every day, combination of route information over a plurality of days may pose a risk that an individual is identified. Therefore, for route information, it shall be understood that the route is divided into three portions (departure, intermediate and arrival) and the information is converted to dummy vehicle numbers by using different rules. For example, as shown in FIG. 14, for route information of a day, the vehicle number 100 is processed into a dummy vehicle number A1 for the departure portion, a dummy vehicle number A2 for the intermediate portion, and a dummy vehicle number A3 for the arrival portion. With such arrangement, the user cannot determine that vehicle numbers A1, A2 and A3 are of the same vehicle. In addition, even for route information by days, identification of an individual will be prevented by converting information to dummy vehicle numbers by using different rules. For example, the departure, the intermediate and the arrival portions of route information of a certain day are processed into dummy vehicle numbers A1, A2 and A3, and route information of the following day is processed into B1, B2 and B3.

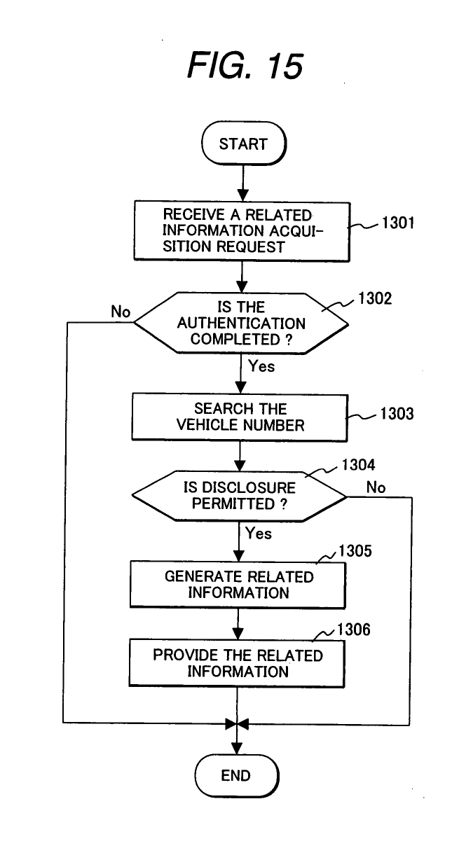

Next, processing steps that the information provision unit 211 returns related information in response to a request from the information acquisition unit 202 will be described with reference to FIG. 15.

FIG. 15 is a flow chart illustrating processing that an information provision unit 211 returns related information, responding to a request from the information acquisition unit 202.

First, the information provision unit 211 of the mediation server 105 receives a related information acquisition request from the information acquisition unit 202 of the user terminal unit 102 (Step 1301). At this time, a user ID, a password and a dummy vehicle number are designated by the information acquisition unit 202. The information provision unit 211 replies the related information of the designated dummy vehicle number.

Next, authentication is carried out to check if the user is an authorized user or not (Step 1302). For the authentication steps, first, a user ID and a password are transmitted to the authentication unit 241 from the information provision unit 211. The authentication unit 241 refers to the user information 242 to checks if combination of the specified user ID and the password has been registered or not. If the combination has been registered, the authentication unit 241 replies successful authentication, or result of failed authentication for the case of failed authentication, to the information provision unit 211. For the case of successful authentication, the step proceeds to Step 1303, or, for the case of failed authentication, failed authentication is notified to the information acquisition unit 202, and the processing is terminated.

Next, the original vehicle number, the acquisition date and time, and the data name are searched from the notified dummy vehicle number via the vehicle information management unit 232 of the vehicle information management server 107 (Step 1303). Then, the vehicle number, the acquisition date and time and the data name are transmitted to the disclosure conditions management unit 243 to check whether disclosure of data designated to the eligible user is permitted or not (Step 1304). If disclosure is permitted, the step advances to Step 1305. If disclosure is not permitted, failed authentication is notified to the information acquisition unit 202, and the processing is terminated.

For the case that disclosure is permitted, related information which makes the already provided information ready for computer-assisted name identification is generated (Step 1305).

The related information generation unit 231 refers to the processing history 233 to searches the original vehicle number that associates with the designated dummy vehicle number. The related information generation unit 231 generates related information “dummy vehicle number=original vehicle number” and transmits the information to the information provision unit 211. For example, since searching of a dummy vehicle number “A1B1C1D1” will result in the original vehicle number 100, related information “A1B1C1D1=100” is generated and transmitted. Finally, the related information thus generated is replied to the information acquisition unit 202 (Step 1305).

An example of using the related information will be described later with a specific example in detail.

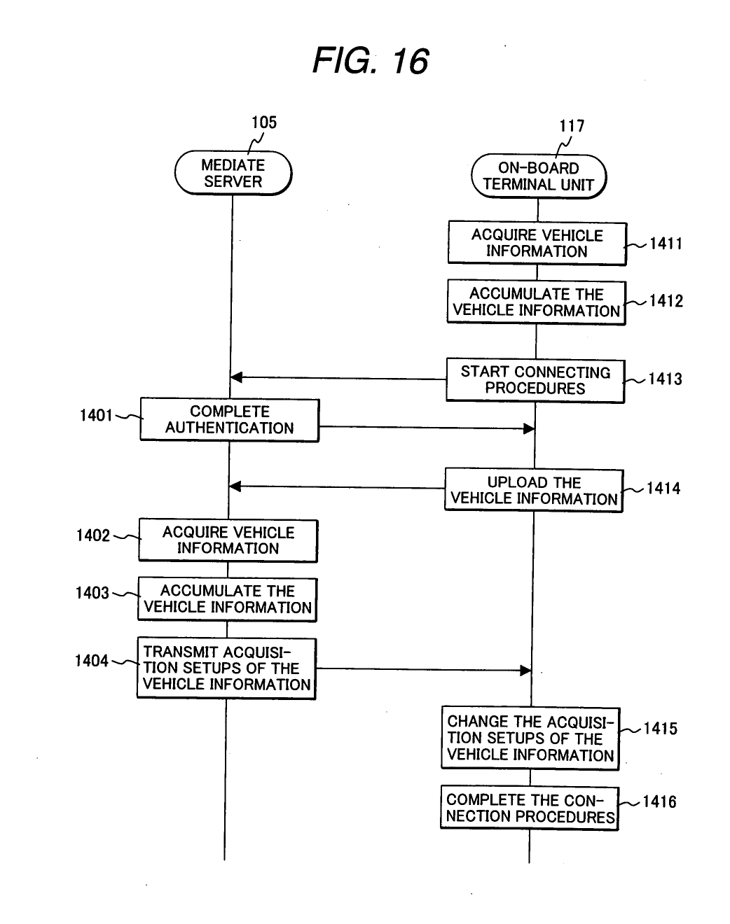

Next, sequence that is exchanged at the time of acquiring vehicle information between the on-board terminal unit 117 and the mediation server 105 will be described with reference to FIG. 16.

FIG. 16 is a sequence diagram for processing vehicle information collection between an on-board terminal unit 117 and a mediation server 105.

The on-board terminal unit 117 and the mediation server are not always-connected and may be connected as required depending on actions of the driver 116. Therefore, in the on-board terminal unit, vehicle information is accumulated for a certain period of time for collective uploading. First, the on-board terminal unit 117 acquires information of ECU via the vehicle information acquisition unit 256 (Step 1411). Methods for collecting vehicle information include two methods: a method for acquiring information that is delivered with push distribution from ECU; and a method for acquiring information by inquiring ECU.

Next, the on-board terminal unit 117 accumulates the vehicle information acquired in Step 1411 in the vehicle information 255 via the vehicle information accumulation unit 254 (Step 1412). In the on-board terminal unit 117, Steps 1411 and 1412 are executed repeatedly.

Here, connection with the mediation server 105 is started as being triggered by actions of the driver 116 such as pressing on the connection button, etc. (Step 1413). At this time, an ID and a password that can uniquely identify the on-board terminal unit 117 are transmitted. At the side of the mediation server 105, authentication is carried out in Step 1401 based on the on-board terminal ID and the password. In the case of successful authentication, success information is replied to the on-board terminal unit, and, for the case of failed authentication, the connection is disconnected.

At the side of the on-board terminal unit 117, vehicle information that is accumulated within the on-board terminal unit is collectively uploaded (Step 1414). At the side of the mediation server 105, the vehicle information that is uploaded in Step 1402 in the vehicle information collection unit is acquired.

Then, the mediation server 105, after enabling identification of a vehicle by affixing a vehicle number to the vehicle information thus uploaded, accumulates the information in the vehicle information 235 via the vehicle information accumulation unit 234 (Step 1403).

Next, the mediation server 105 transmits new vehicle information acquisition setups to the on-board terminal unit 117 (Step 1404). Here, the vehicle information acquisition setups imply setup information related to the acquisition methods of the vehicle information 235 to be acquired within an on-board terminal unit. In the setup information, it is defined which data is acquired in what cycle. At the side of the on-board terminal unit, the vehicle information acquisition setups thus transmitted are set up (Step 1415), and the connection with the mediation server 105 is terminated (Step 1416). Within the on-board terminal unit, the vehicle information 235 is accumulated based on the new vehicle information acquisition setups.

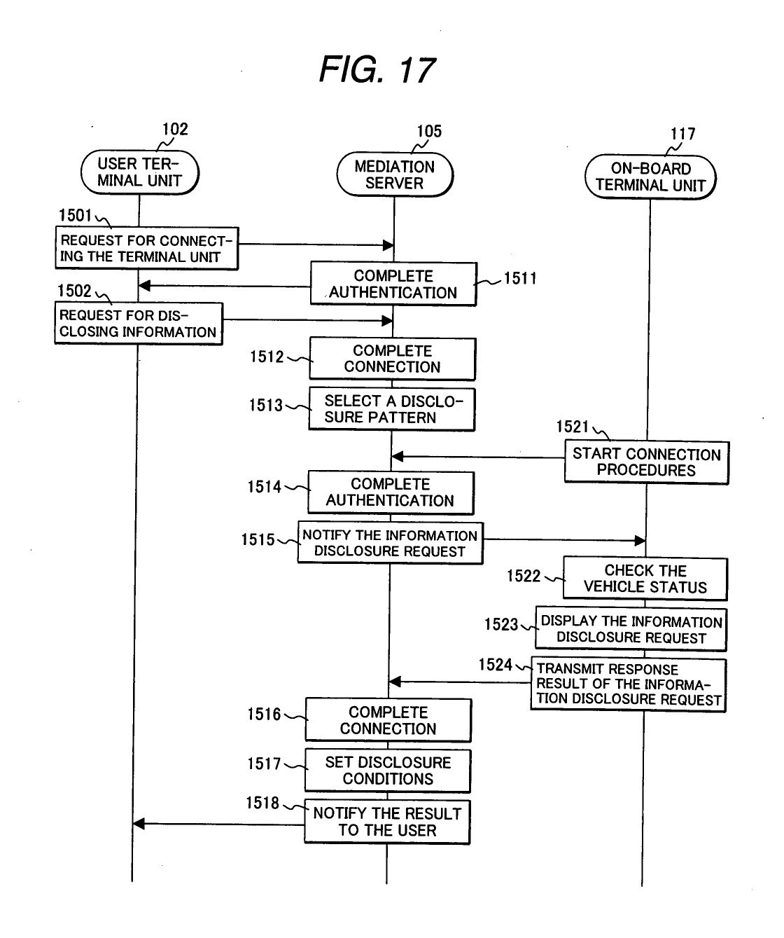

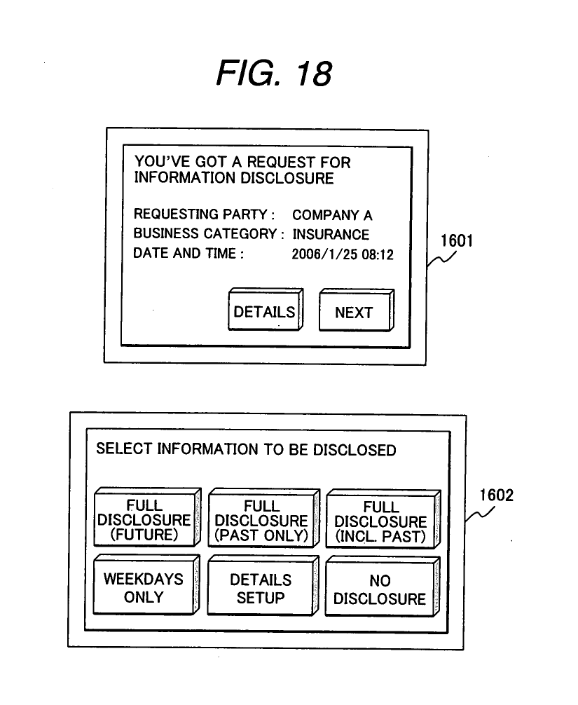

Next, processing steps for requesting information disclosure by the user 101 to the driver 116 will be described with reference to FIGS. 17 and 18.

FIG. 17 is a sequence diagram for processing steps of disclosing information to a driver 116 by a user 101.

FIG. 18 is a diagram illustrating an example of information disclosure request screen to be displayed on the window of the on-board terminal unit 117.

First, a connection request is transmitted to the mediation server 105 from the user terminal unit 102 (Step 1501). At this time, a user ID and a password are transmitted. At the side of the mediation server 105, authentication is executed based on the user ID and the password thus transmitted (Step 1511). For the case of successful authentication, a reply of success is returned, and, for the case of failed authentication, the connection is disconnected.

At the side of the user terminal unit 102, a disclosure request is transmitted from the information disclosure request unit 201 (Step 1502). At this time, the user 101 may also request for disclosing past information that is already accumulated in the vehicle information management server 107. Therefore, the information disclosure request unit 201 transmits a disclosure request by designating vehicles to be disclosed, data items, acquisition date and time, etc. To identify a vehicle, it is possible to designate the vehicle based on vehicle attributes such as location. An example is a vehicle that is located in Kanagawa Prefecture. For the case that marketing analysis is conducted by the Insurance, etc., such identification of vehicles is required since it is necessary to target specific customers. In addition to designate vehicles to be disclosed, data items, acquisition date and time, etc., it is also possible to transmit a request, by designating dummy vehicle numbers in the acquired information 203, for disclosing associating vehicle information. At the side of the mediation server 105, the disclosure request is received and the connection is disconnected (Step 1512). Then, in the vehicle information disclosure management unit 215, the disclosure pattern 216 that is appropriate to the disclosure request received is selected. (Step 1513). For example, when a request is made for disclosure of route information, “route information”, “route information (including past data)”, “route information (of weekdays only)”, “route information (of holidays only), etc. whose disclosure data item 902 are the same are selected as disclosure patterns. These selected disclosure patterns are transmitted to the on-board terminal unit 117 for use. On the other hand, at the side of the on-board terminal unit 117, connection with the mediation server 105 is started as being triggered by actions of the driver 116 such as pressing on the connection button, etc. (Step 1521). At this time, an ID and a password that can uniquely identify the on-board terminal unit 117 are transmitted. At the side of the mediation server 105, authentication is carried out based on an on-board device ID and a password. In the case of successful authentication, success information is replied to the on-board terminal unit, and, for the case of failed authentication, the connection is disconnected. In Step 1502, a request received from the information disclosure request unit 201 is transmitted to the information disclosure setup unit 251 of the on-board terminal unit 117 (Step 1515). At the side of the on-board terminal unit 117, the vehicle status is checked by the vehicle status management unit 252. The vehicle status management unit 252 can determine the vehicle status by acquiring information of ECU via the vehicle information acquisition unit 256. For example, it is possible to determine whether the vehicle is traveling or in a stop by acquiring vehicle speed information from ECU. Since it is not recommended for safety reasons to display information on the screen while the vehicle is traveling, processing is interrupted until the vehicle stops when the vehicle is in traveling status. When the vehicle is in a stop, information of the information disclosure request is displayed on the screen of the on-board terminal unit 117 (Step 1523). It should be noted that the vehicle status can be defined by utilizing information regarding engine operation, traveling straight/traveling around a curve, distance between a car ahead and a following car, whether or not a fellow passenger is on-board, speed, location, etc. in addition to the status of traveling/in a stop.

Here, for example, a window 1601 as shown in FIG. 18 is displayed. On the window 1601, general information on a person who is requesting information disclosure is displayed. Now, a click on the “Details” button enables browsing of more detailed information. A click on the “Next” button, the window will shift to a window 1602. The window 1602 is a window for selecting information to be disclosed, and disclosure pattern names are displayed in button shape. The driver 116 can easily set even complex disclosure setups over a plurality of items just by selecting one of the buttons. Of course, it is possible to set the items in details one by one. However, many of the drivers 116 are amateurs in terms of vehicle and it is difficult for them to achieve complex information setups. Therefore, a more efficient method will be to set disclosure patterns by using words that are understandable even for the driver 116, thereby enabling the driver 116 to select permission or no permission of disclosure according to the disclosure patterns.

As stated above, the driver 116 makes judgment as to whether information should be disclosed or not after seeing the information displayed and select the result with actions such as pressing a button. Then, the response result selected by the driver 116 is transmitted to the mediation server 105 (Step 1524).

At the side of the mediation server 105, the result is received, and connection is disconnected (Step 1516). Then, at the side of the mediation server 105, the disclosure conditions 244 are set/modified based on the response result (Step 1517) and the result is notified to the user 101 (Step 1518).

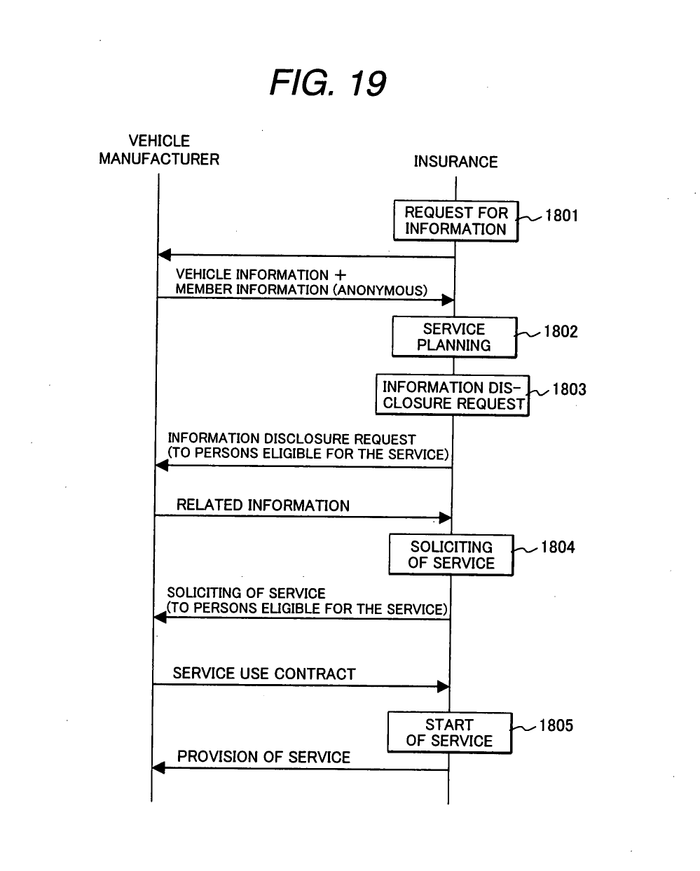

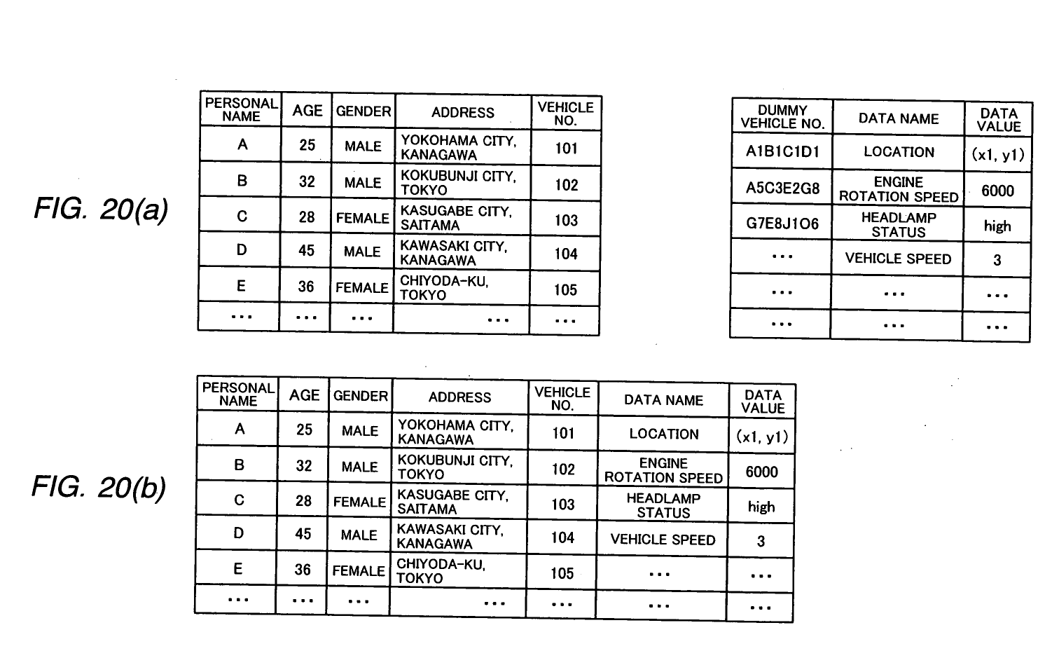

Next, processing steps for the case that the Insurance is implementing marketing analysis and starting service to customers will be described with reference to FIGS. 19 and 20.

FIG. 19 is a flow chart illustrating processing steps for executing marketing analysis and implementing service to a customer by the Insurance.

FIG. 20 is a diagram illustrating a display example of information provided by a customer to be displayed on a user terminal unit 102.

First of all, to create a new insurance menu, provision of vehicle information and member information is requested to a car manufacturer (Step 1801). Here, it shall be understood that an agreement of information provision has already been contracted between the car manufacturer and the Insurance. However, according to the Private Information Protection Law, since provision of information is prohibited in a form that can identify an individual, information will be provided to the Insurance after processing and anonymizing the information to prevent computer-assisted name identification. The Insurance plans a new insurance menu based on such anonymized information (Step 1802). For example, acquired information will be analyzed, percentage of persons by ages and genders will be studies, and statistical analysis will be made based on the core distribution of travel distance, core distribution of destination and route point, operation status of engine, the accelerator pedal position, the brake pedal position, etc. Analysis of the anonymized information enables to determine whether market needs are expected or not, and, upon completing planning of a new insurance menu, information disclosure is requested to target customers (Step 1803). At this time, the Insurance has not been able to identify individuals yet, but they have been able to identify individuals only as customers who uses vehicles for which the vehicle information has been acquired.” Therefore, the Insurance will have to designate specified vehicle information and make a request for disclosing member information associating with the vehicle information. Here, with conventional methods, there is no choice but to issue disclosure requests to all persons, which is very inefficient. If it is understood that a certain customer is a target customer for the new service, it will be possible to take more effective actions for information disclosure, such as offering reward for information disclosure. When permission can be obtained from a customer, related information is transmitted from the car manufacturer. The Insurance, by utilizing the related information thus transmitted, can immediately identify the individual. With conventional methods, since vehicle information is changing day by day, it is not possible to ensure association with vehicle information that was analyzed in Step 1802. Eventually, analysis will have to be conducted again from scratch. With the present invention, however, since anonymizing of information at the time of past analysis can be cancelled, it is possible to expedite business tasks. Therefore, it is possible to solicit service immediately (Step 1804), which can induce start of service (Step 1805). In addition, conventional methods had a problem that, since acquisition of information necessary for analysis is initiated after obtaining permission from a customer, it takes time to collect information. With the present invention, however, it is possible to shorten time for acquiring information for analysis since a car manufacturer can periodically acquire vehicle information and acquisition of information including vehicle information that has been already acquired is possible.

On the user terminal unit 102, when disclosure of vehicle information to the user 101 is restricted, a vehicle number is displayed as dummy information in the form that computer-assisted name identification can be prevented, as shown in FIG. 20A. Then, when disclosure is permitted, it is possible to display the vehicle number in the form shown in FIG. 20B on the user terminal unit 102 after applying computer-assisted name identification according to related information.

What is claimed is:

1. A system for mediating information which includes a user terminal unit, an information provider terminal unit and a mediation server,
wherein said user terminal unit and said information provider terminal unit are connected to said mediation server through a network and provided information on an information provider is transmitted to said user terminal unit from said information provider terminal unit via said mediation server, the system comprising:
a device which acquires provided information on said information provider from said information provider terminal unit and accumulates the provided information;
a device which accumulates attribute information on said information provider; and
a device which stores definition information of disclosure conditions to said user for combination of respective items of provided information on said information provider with respective items of attribute information on said information provider;
wherein said mediation server modifies methods for providing said user terminal unit with combination of respective items of provided information on said information provider and respective items of attribute information on said information provider based on the definition information of the disclosure conditions to said user.

2. A system for mediating information according to claim 1,
wherein said mediation server, when disclosure of combination of respective items of provided information on said information provider and respective items of attribute information on said information provider is not permitted, provides information by rewriting data for applying computer-assisted name identification on provided information on said information provider and attribute information on said information provider to dummy information.

3. A system for mediating information according to claim 2,
wherein a rule for rewriting data for applying computer-assisted name identification on provided information on said information provider and attribute information on said information provider to dummy information is changeable for each date, each day of the week or at regular time intervals.

4. A system for mediating information according to claim 1,
wherein said information provider terminal unit transmits disclosure conditions to said user to said mediation server; and
said mediation server provides related information for applying computer-assisted name identification on provided information on said information provider and attribute information on said information provider for the provided information on said information provider and attribute information on said information provider that are provided to said user.

5. A system for mediating information according to claim 1,
wherein definition information of disclosure conditions for said user is defined according to user attributes including, at least, a company to which said user belongs, a business category, a department and a method for use.

6. A system for mediating information according to claim
wherein information provision history of information provided to said user is stored; and
based on said information provision history, a method for providing combination of respective items of provided information on said information provider and respective items of attribute information on said information provider to said user terminal unit is determined.

7. A system for mediating information according to claim 2,
wherein said information user terminal unit is an on-board terminal unit; and
said mediation server, concerning provision of route information of a vehicle, divides the route information into portions of departure, intermediate and arrival and rewrites each of the portions to different dummy information.

8. A system for mediating information,
wherein said information provider terminal unit is an on-board terminal unit,
said user terminal unit requests, via said mediation server, said information provider terminal unit to disclose provided information on said information provider and attribute information on said information provider,
said mediation server, when a request is made from said user terminal unit for disclosing provided information on said information provider and attribute information on said information provider to said information provider terminal unit via said mediation server, set the scope of information to be disclosed to said user based on information items of an automobile on which an on-board terminal unit is to be mounted, the information items containing: accumulated provided information on information providers; provided information already provided to users; information whether or not either of provided information which is generated in the future, or combination of the provided information, should be disclosed; time attributes including date, a day of the week, and time; engine rotation speed; route; and location.

9. A system for mediating information according to claim 8,
wherein the scope of information to be disclosed to said user is registered in the form of patterns; and
the scope of disclosure is set by designating a pattern name by said user.

10. A system for mediating information according to claim 8,
wherein, when a request is made from said user terminal unit via said mediation server to said information provider terminal unit for disclosing provided information on said information provider and attribute information on said information provider, whether or not the information disclosure request from said user should be displayed on the window of said on-board terminal unit, based on a vehicle status including a traveling/idling/engine stop and location of a an automobile on which said on-board terminal unit is mounted.

11. A system for mediating information which includes a user terminal unit and an information provider terminal unit and provides provided information on an information provider to said user terminal unit from said information provider terminal unit,
wherein a mediation server is connected to said user terminal unit and said information provider terminal unit via a network, said mediation server including:
a device which acquires provided information on an information provider from said information provider terminal unit;
a device which transmits the provided information of said information provider to a provided information management server;
a device which receives the provided information of said information provider from said provider information management server;
a device which receives attribute information on said information provider from said information provider management server; and
a device which receives definition information on disclosure conditions to said user that are defined for combination of respective items of provided information on said information provider and respective items of attribute information on said information provider from a user management server; and wherein
said mediation server, based on said definition information on disclosure conditions, modifies methods for providing said user terminal unit with combination of respective items of provided information on said information provider and respective items of attribute information on said information provider.

12. A method for mediating information,
wherein a user terminal unit, an information provider terminal unit and a mediation server are incorporated; and
said user terminal unit and said information provider terminal units are connected to said mediation server via a network, and provided information on an information provider via said mediation server is provided to said user terminal unit from said information provider terminal unit,
said method comprising the steps of:
acquiring provided information on an information provider from said information provider terminal unit;
accumulating provided information on an information provider from said information provider terminal unit;
accumulating attribute information on said information provider;
storing definition information on disclosure conditions to said user for combination of respective items of provided information on said information provider and respective items of attribute information on said information provider; and
said mediation server further comprising the step of modifying, based on said definition information on disclosure conditions, methods for providing said user terminal unit with combination of respective items of provided information on said information provider and respective items of attribute information on said information provider.
